(19) United States
(12) Patent Application Publication
(10) Pub. No.: US 2003/0187651 A1
(43) Pub. Date: Oct. 2, 2003

(54) Voice synthesis system combining recorded voice with synthesized voice

(75) Inventor: Wataru Imatake, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/307,998

(22) Filed: Dec. 3, 2002

(30) Foreign Application Priority Data
Mar. 28, 2002 (JP) 2002-093189

(51) Int. Cl. G10L 13/06

(52) U.S. Cl. 704/269

(57) ABSTRACT

A voice synthesis system analyzes an input character string, determining a part for which to use recorded voice and a part for which to use synthesized voice, extracts voice data for the part for which to use recorded voice from a database and extracts its feature amount. Then, the system synthesizes voice data to fit the extracted feature amount for the part for which to use synthesized voice, and combines/outputs these pieces of voice data.

### BACKGROUND OF THE INVENTION

1. Field of the Invention

The present invention relates to a voice synthesis system generating voice data by combining pre-recorded data with synthesized data.

2. Description of the Related Art

In a conventional voice synthesis system, “synthesized data” generated by voice synthesis and pre-recorded “stored data” are sequentially combined to generate a sequence of voice data.

FIG. 1 shows an example of such voice data. In FIG. 1, the voice data in variable parts 11 and 13 correspond to the synthesized data, and the voice data in fixed parts 12 and 14 correspond to the stored data. A sequence of voice data is generated by sequentially combining the respective voice data in the variable part 11, fixed part 12, variable part 13 and fixed part 14.

FIG. 2 shows the configuration of a conventional voice synthesis system. The voice synthesis system shown in FIG. 2 comprises a character string analyzing unit 21, a stored data extracting unit 22, database 23, a synthesized voice data generating unit 24, a waveform dictionary 25 and a waveform combining unit 26.

The character string analysis unit 21 determines for which part of an input character string 31 stored data should be used and for which part of it synthesized data should be used. The stored data extracting unit 22 extracts necessary stored data 32 from the database 23. The synthesized voice data generating unit 24 extracts waveform data from the waveform dictionary 25 and generates synthesized voice data 33. Then, the waveform combining unit 26 combines the input stored data 32 with the synthesized voice data 33 to generate new voice data 34.

Besides a method for generating new voice data by combining stored data with synthesized data, there is a method for generating the new voice data of an input character string for which to use only either stored data or synthesized data. FIG. 3 shows the respective features of these methods.

Although a method using only synthesized data has the advantage that there are many voice data variations and there are a small number of generating processes, it has the disadvantage that voice quality is low compared with a method using only stored data. However, although a method using only stored data has the advantage that voice quality is high, it has the disadvantage that there are few variations and there are a large number of generating processes.

However, a method using both types of the data has the advantage that the voice quality of stored data can be guaranteed and there is better balance between recording work and variations of generable voice data in the case that various sequences of voice data are generated by changing a word in a standard sentence.

However, the conventional voice synthesis system has the following problem.

In the voice synthesis system shown in FIG. 2, synthesis data and stored data are simply combined sequentially. The recorded voice which is the basis of the waveform data of a waveform dictionary and the recorded voice of stored data are often generated by different narrators. For this reason, there is voice discontinuity between synthesized data and stored data. Therefore, holistically natural voice data cannot be obtained by simply combining these pieces of data.

### SUMMARY OF THE INVENTION

It is an object of the present invention to provide a voice synthesis system generating natural voice data by combining recorded voice data and synthesized voice data.

The voice synthesis system of the present invention comprises a storage device, an analysis device, an extraction device, a synthesis device and an output device.

The storage device stores recorded voice data in relation to each of a plurality of partial character strings. The analysis device analyzes an input character string, and determines partial character strings for which to use recorded voice and partial character strings for which to use synthesized voice. The extraction device extracts voice data for a partial character string for which to use recorded voice from the storage device, and extracts the feature amount of the extracted voice data. The synthesis device synthesizes voice data to fit the extracted feature amount for a partial character string for which to use synthesized voice. The output device combines and outputs the extracted voice data and synthesized voice data.

### BRIEF DESCRIPTIONS OF THE DRAWINGS

FIG. 1 shows an example of voice data.

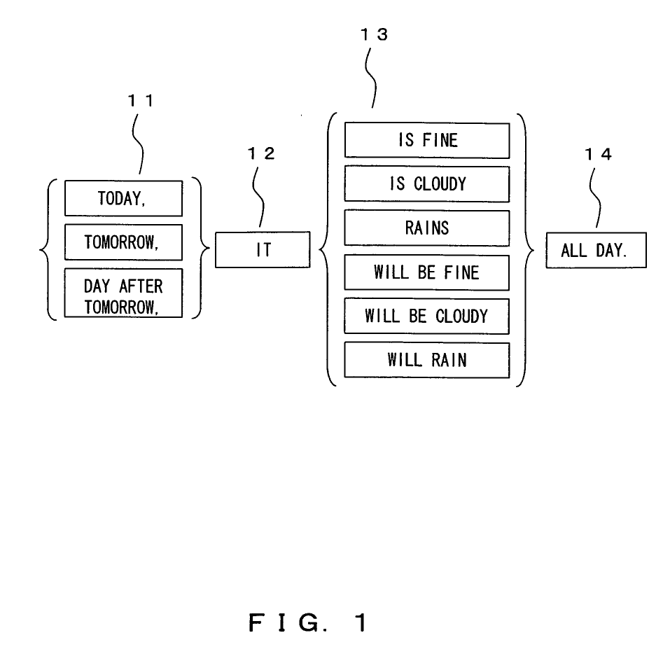

FIG. 2 shows the configuration of the conventional voice synthesis system.

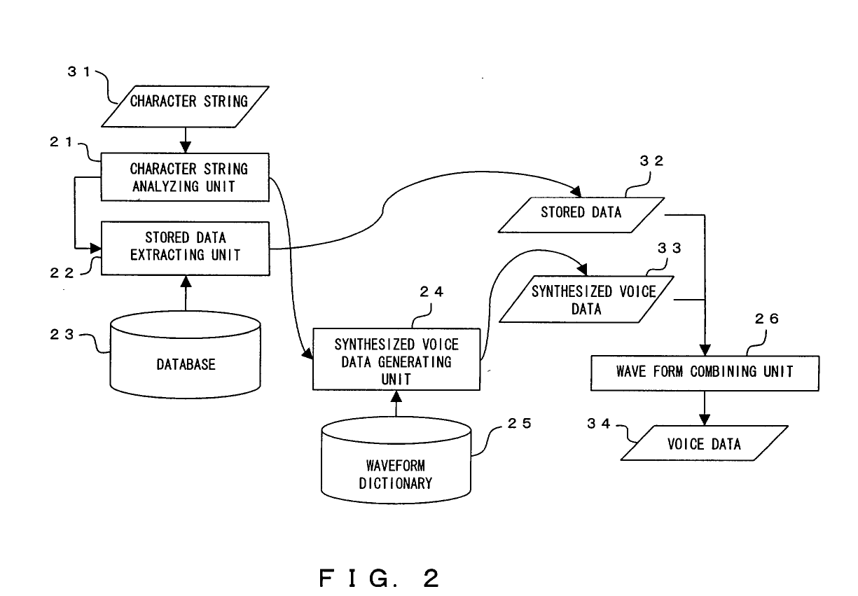

FIG. 3 shows the features of the conventional voice data.

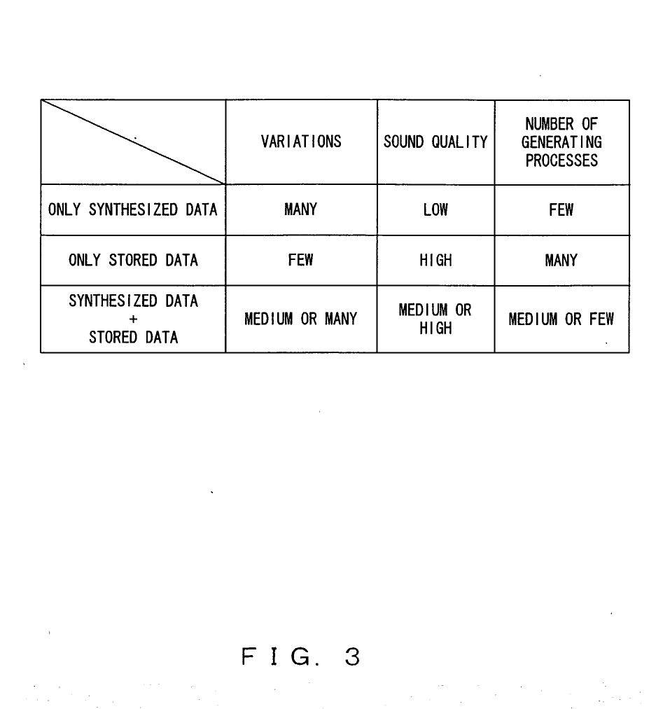

FIG. 4 shows the basic configuration of the voice synthesis system of the present invention.

FIG. 5A shows the configuration of the first voice synthesis system of the present invention.

FIG. 5B is a flowchart showing the first voice synthesis process.

FIG. 6A shows the configuration of the second voice synthesis system of the present invention.

FIG. 6B is a flowchart showing the second voice synthesis process.

FIG. 7A shows the configuration of the third voice synthesis system of the present invention.

FIG. 7B is a flowchart showing the third voice synthesis process.

FIG. 8 shows the first stored data.

FIG. 9 shows a focused frame.

FIG. 10 shows the first target frame.

FIG. 11 shows the second target frame.

FIG. 12 shows an auto-correlation array.

FIG. 13 shows pitch distribution.

FIG. 14 shows the second stored data.

FIG. 15 shows the third stored data.

FIG. 16 shows the voice waveform of “ma”.

FIG. 17 shows the consonant part of “ma”.

FIG. 18 shows the vowel part of “ma”.

FIG. 19 shows the configuration of a information processing device.

FIG. 20 shows examples of storage media.

### DESCRIPTIONS OF THE PREFERRED EMBODIMENTS

The preferred embodiments of the present invention are described in detail below with reference to the drawings.

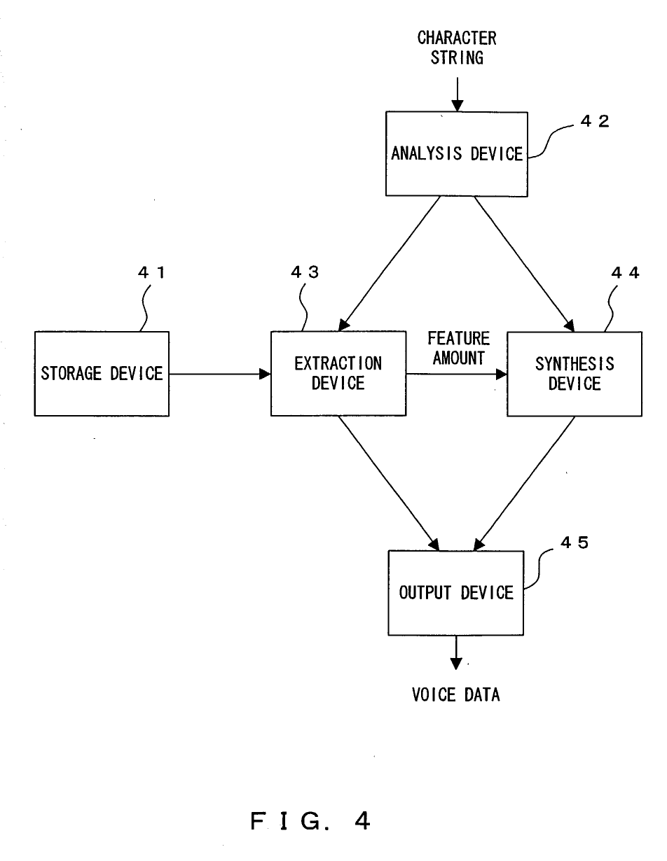

FIG. 4 shows the basic configuration of the voice synthesis system of the present invention. The voice synthesis system shown in FIG. 4 comprises a storage device 41, an analysis device 42, an extraction device 43, a synthesis device 44 and an output device 45.

The storage device 41 stores recorded voice data in relation to each of a plurality of partial character strings. The analysis device 42 analyzes an input character string, and determines partial character strings for which to use recorded voice and partial character strings for which to use synthesized voice. The extraction device 43 extracts voice data for a partial character string for which to use recorded voice from the storage device 41, and extracts a feature amount from the extracted voice data. The synthesis device 44 synthesizes voice data to fit the extracted feature amount for a partial character string for which to use synthesized voice. The output device 45 combines and outputs the extracted voice data and synthesized voice data.

The analysis device 42 transfers a partial character string for which to use recorded voice of an input character string and a partial character string for which to use synthesized voice to the extraction device 43 and synthesis device 44, respectively. The extraction device 43 extracts voice data corresponding to the partial character string received from the analysis device 42, from the storage unit 41, extracts a feature amount from the voice data and transfers the feature amount to the synthesis device 44. The synthesis device 44 synthesizes voice data corresponding to the partial character string received from the analysis device 42 so that synthesized data fit the feature amount received from the extraction device 43. Then, the output device 45 generates output voice data by combining the voice data extracted by the extraction device 43 with the synthesized voice data, and outputs the data.

According to such a voice synthesis system, since the difference in a feature amount between the recorded voice data and synthesized voice data decreases, the discontinuity of these pieces of voice data decreases. Therefore, more natural voice data can be generated.

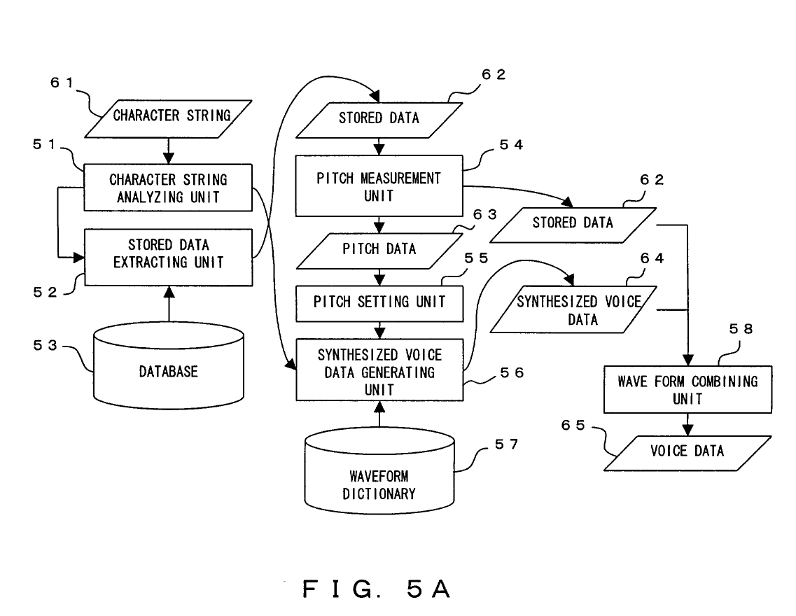

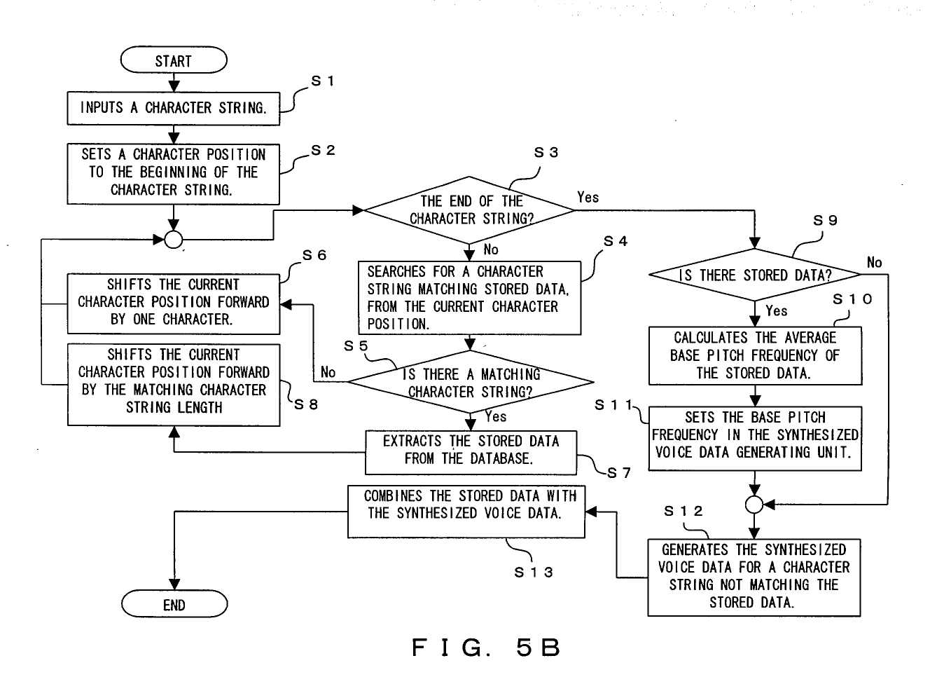

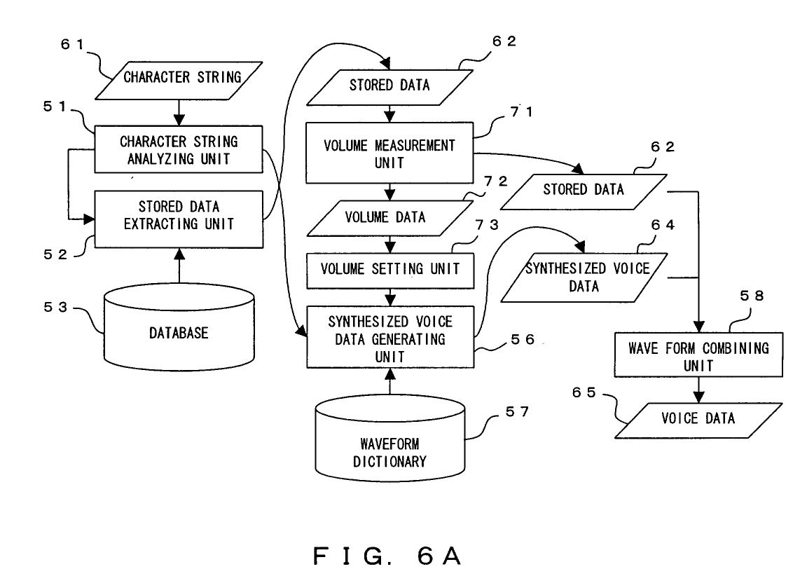

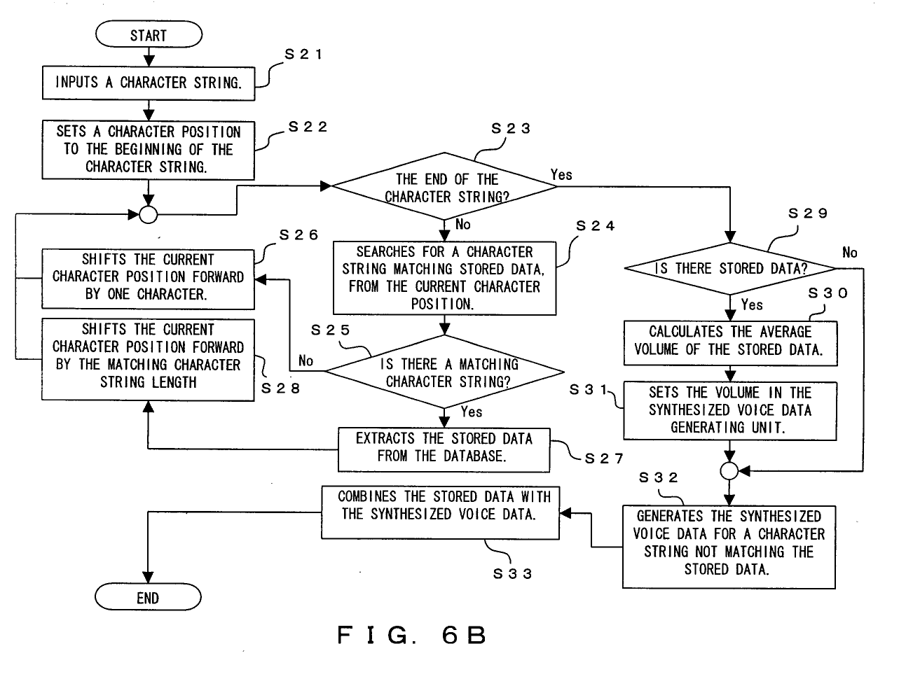

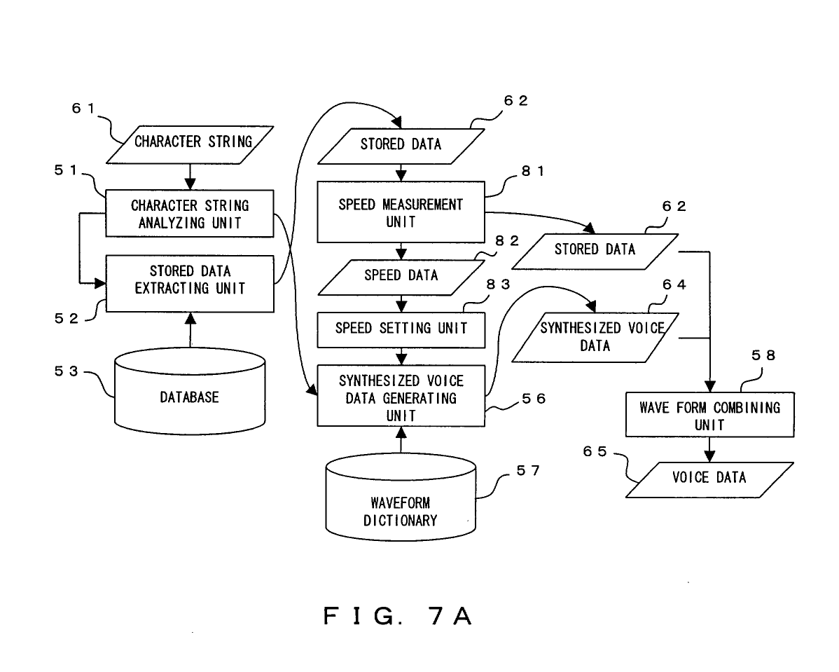

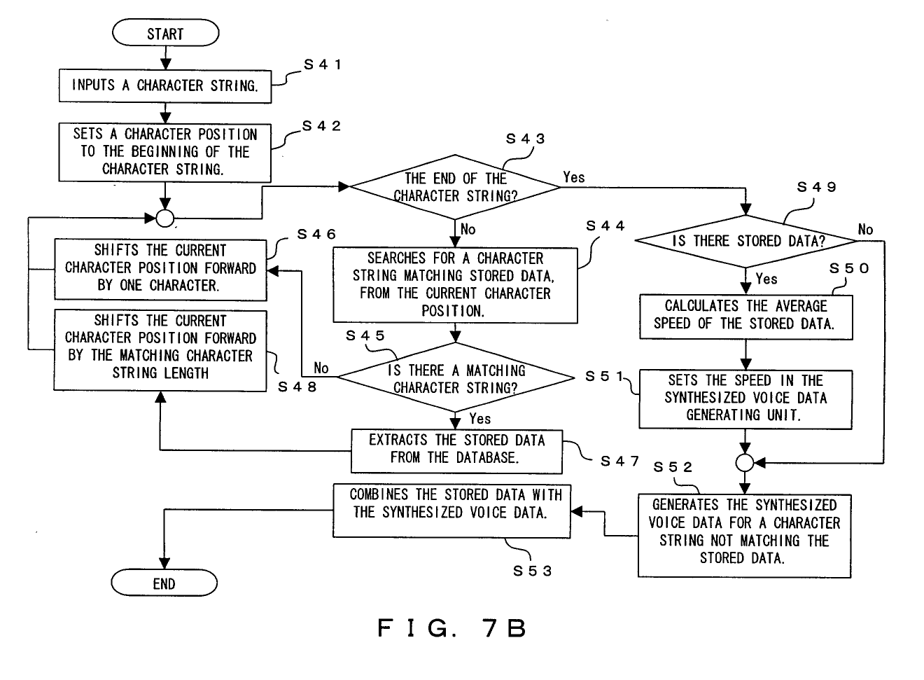

The storage device 41 shown in FIG. 4, corresponds to, for example, the database 53, which is described later in FIGS. 5A, 6A and 7A. The analysis device 42 corresponds to, for example, the character string analysis unit 51 shown in FIG. 5A, 6A and 7A. The extraction device 43, corresponds to, for example, the stored data extraction unit 52, the pitch measurement unit 54 shown in FIG. 5A, the volume measurement unit 71 shown in FIG. 6A and the speed measurement unit 81 shown in FIG. 7A. The synthesis device 44, corresponds to, for example, the waveform combining unit 58 shown in FIGS. 5A, 6A and 7A.

In the hybrid voice synthesis system of the present invention, prior to the generation of synthesized voice data, the feature amount of voice data to be used as stored data is extracted in advance, and synthesized voice data to fit the feature amount is generated. Thus, the quality discontinuity of the final voice data generated can be reduced.

For the feature amount of voice data, a base pitch, a volume, a speed or the like is used. A base pitch, a volume and a speed represent the pitch, power and speaking speed, respectively, of voice.

For example, by using a base pitch frequency extracted from stored data as the parameter of voice synthesis, synthesized voice data to fit the base pitch frequency can be generated. Thus, synthesized data and stored data that have the same base pitch frequency can be sequentially combined, and the base pitch frequency of the final voice data generated can be unified. Therefore, there is little difference in voice pitch between synthesized data and stored data, and more natural voice data can be generated, accordingly.

By using a volume extracted from stored data as the parameter of voice synthesis, synthesized voice data to fit the volume can be generated. In this case, the volume of the final voice data generated is unified, and there are little difference in voice pitch between synthesized data and stored data, accordingly.

By using a speed extracted from stored data as the parameter of voice synthesis, synthesized voice data to fit the speed can be generated. In this case, the speed of the final voice data generated is unified, and there are little difference in voice pitch between synthesized data and stored data, accordingly.

FIG. 5A shows the configuration of a hybrid voice synthesis system using base pitch frequency as a feature amount. The voice synthesis system shown in FIG. 5A comprises a character string analyzing unit 51, a stored data extracting unit 52, database 53, a pitch measurement unit 54, a pitch setting unit 55, a synthesized voice data generating unit 56, a waveform dictionary 57 and a waveform combining unit 58.

The database 53 stores pairs containing recorded voice data (stored data) and a character string. The waveform dictionary 57 stores waveform data in units of phonemes.

The character string analyzing unit 51 determines for which part of an input character string 61 stored data is used, and for which part synthesized data is used, and calls the stored data extracting unit 52 or synthesized voice data generating unit 56, depending on the determined partial character string.

The stored data extracting unit 52 extracts stored data 62 corresponding to the partial character string of the input character string 61 from the database 53. The pitch measurement 54 measures the base pitch frequency of the stored data 62 and outputs pitch data 63. The pitch setting unit 55 sets the base pitch frequency of the input pitch data 63 in the synthesized voice data generating unit 56.

The synthesized voice data generating unit 56 extracts corresponding waveform data from the waveform dictionary 57, based on the partial character string of the character string 61 and measured base pitch frequency, and generates synthesized voice data 64. Then, the waveform combining unit 58 generates and outputs voice data 65 by combining the input stored data 62 with synthesized voice data 64.

FIG. 5B is a flowchart showing an example of the voice synthesis process of the voice synthesis method shown in FIG. 5A. First, when a character string 61 is input to the character string analyzing unit 51 (step S1), the character string analyzing unit 51 sets a pointer indicating a current character position to the leading character of the input character string (step S2), and checks whether the pointer points at the end of the character string (step S3). If the pointer points at the end of the character string, it means that the matching processes for stored data of all the characters in the input character string have finished.

If the pointer does not point at the end, the character string analyzing unit 51 calls the stored data extracting unit 52 and searches for a character string matching the stored data from the current character position (step S4). Then, the unit 51 checks whether the stored data and a partial character string match (step S5). If the stored data and the partial character string do not match, the unit 51 shifts the pointer forward by one character (step S6) and detects a matched partial character string by repeating the processes in steps S3 and after.

If in step S5 the stored data and the partial character string match, the stored data extracting unit 52 extracts the corresponding stored data 62 from the database 53 (step S7). Then, the character string analyzing unit 51 shifts the pointer forward by the length of the matched partial character string (step S8) and detects the next matched partial character string by repeating the processes in steps S3 and after.

If in step S3 the pointer points at the end, the matching process terminates. Then, the pitch measurement unit 54 checks whether there is data extracted as stored data (step S9). If there is extracted stored data, the base pitch frequencies of all the pieces of extracted data are measured and their average value is calculated (step S10). Then, the unit 54 outputs the calculated average value to the pitch setting unit 55 as pitch data 63.

The pitch setting unit 55 sets the average base pitch frequency in the synthesized voice data generating unit 56 as a voice synthesis parameter (step S11), and the synthesized voice data generating unit 56 generates synthesized voice data 64 with the set base pitch frequency for a partial character string that does not match stored data (step S12). Then, the waveform combining unit 58 generates and outputs voice data by combining the obtained stored data 62 with the synthesized voice data 64 (step S13).

If in step S9 there is no extracted stored data, the processes in steps S12 and after are performed, and voice data is generated using only synthesized voice data 64.

FIG. 6A shows the configuration of a hybrid voice synthesis system using a volume as a feature amount. In FIG. 6A, the same reference numbers as those shown in FIG. 5A are attached to the same components as those shown in FIG. 5A. In FIG. 6A, instead of the pitch measurement unit 54 and pitch setting unit 55 which are shown in FIG. 5A, a volume measurement unit 71 and volume setting unit 73 are provided, and for example, a voice synthesis process, as shown in FIG. 6B, is performed.

In FIG. 6B, processes in steps S21 through S29, S32 and S33 are the same as those in step S1 through S9, S12 and S13, respectively, which are shown in FIG. 5B. If in step S29 there is extracted stored data, the volume measurement unit 71 measures the volumes of all the pieces of extracted stored data and calculates their average value (step S30). Then, the unit 71 outputs the calculated average value to the volume setting unit 73 as volume data 72.

The volume setting unit 73 sets the average volume in the synthesized voice data generating unit 56 as a voice synthesis parameter (step S31), and the synthesized voice data generating unit 56 generates synthesized voice data 64 with the set volume for a partial character string that does not match stored data (step S32).

FIG. 7A shows the configuration of a hybrid voice synthesis system using speed as a feature amount. In FIG. 7A, the same reference numbers as those shown in FIG. 5A are attached to the same components as those shown in FIG. 5A. In FIG. 7A, instead of the pitch measurement unit 54 and pitch setting unit 55 which are shown in FIG. 5A, a speed measurement unit 81 and speed setting unit 83 are provided, and for example, a voice synthesis process, as shown in FIG. 7B, is performed.

In FIG. 7B, processes in steps S41 through S49, S52 and S53 are the same as those in step S1 through S9, S12 and S13, respectively, which are shown in FIG. 5B. If in step S49 there is extracted stored data, the speed measurement unit 81 measures the speed of all the pieces of extracted stored data and calculates their average value (step S50). Then, the unit 81 outputs the calculated average value to the speed setting unit 83 as speed data 82.

The speed setting unit 83 sets the average speed in the synthesized voice data generating unit 56 as a voice synthesis parameter (step S51), and the synthesized voice data generating unit 56 generates synthesized voice data 64 with the set speed for a partial character string that does not match stored data (step S52).

Although in step S10 of FIG. 5B, the pitch measurement unit 54 outputs the average base pitch frequency of all the pieces of extracted stored data as pitch data 63, pitch data can also be calculated by another method. For example, a value (maximum value, minimum value, etc.) selected from a plurality of base pitch frequencies or a value calculated by a prescribed calculation method, using a plurality of base pitch frequencies, can also be designated as pitch data. The same is applied to the generation method of volume data 72 in step S30 of FIG. 6B and the generation method of speed data 82 in step S50 of FIG. 7B.

Although in each of the systems shown in FIGS. 5A, 6A and 7A, one feature amount of stored data is used as a voice synthesis parameter, a system using two or more feature amounts can also be built. For example, if base pitch frequency, volume and speed are used as feature amounts, these feature amounts are extracted from stored data and are set in the synthesized voice data generating unit 56. Then, the synthesized voice data generating unit 56 generates synthesized voice data with the set base pitch frequency, volume and speed.

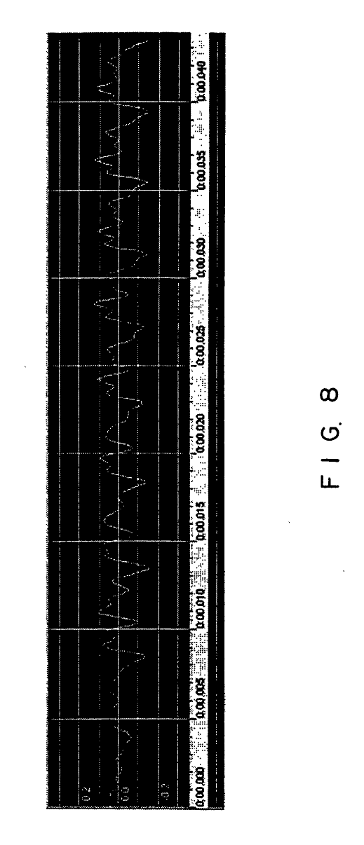

Next, the specific examples of the respective processes of the pitch measurement unit 54, volume measurement unit 71, speed measurement unit 81 and synthesized voice data generation unit 56 are described with reference to FIGS. 8 through 18.

First, the pitch measurement unit 54, for example, calculates the base pitch frequency of stored data, based on the pitch distribution. As a method for calculating pitch distribution, an auto-correlation method, a method for calculating pitch distribution by detecting a spectrum and converting the spectrum into a cepstrum and the like are widely known. As an example, an auto-correlation method is briefly described below.

Stored data is, for example, the waveform data shown in FIG. 8. In FIG. 8, the horizontal and vertical axes represent time and voice level, respectively. A part of such waveform data is clipped by an arbitrary frame, and the frame is shifted backward (leftward) in the direction of the time axis by one sample in one time from a position where the frame is shifted backward from the original position by an arbitrary length. A correlation value between the data in the frame and data originally existing in a shifted position is calculated every time the frame is shifted. Specifically, the calculation is made as follows.

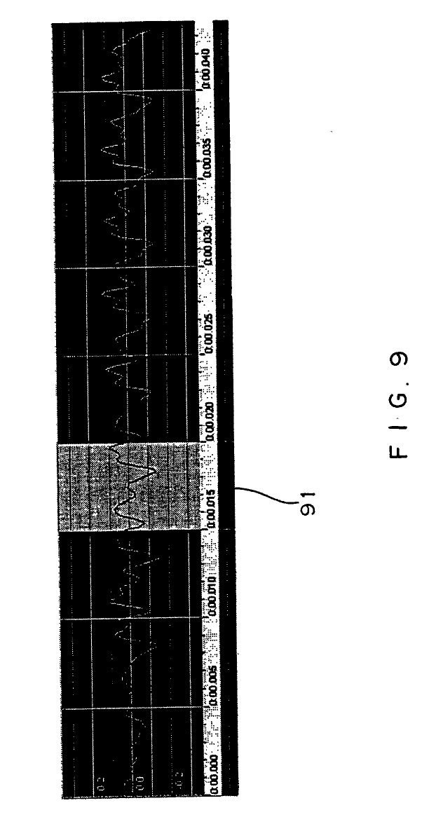

FIG. 9 shows that it is assumed that a frame size is 0.005 seconds and the fourth frame 91 from the top is in the current focus. If the leading frame is in the current focus, calculation is made assuming that there is zero data before the leading frame.

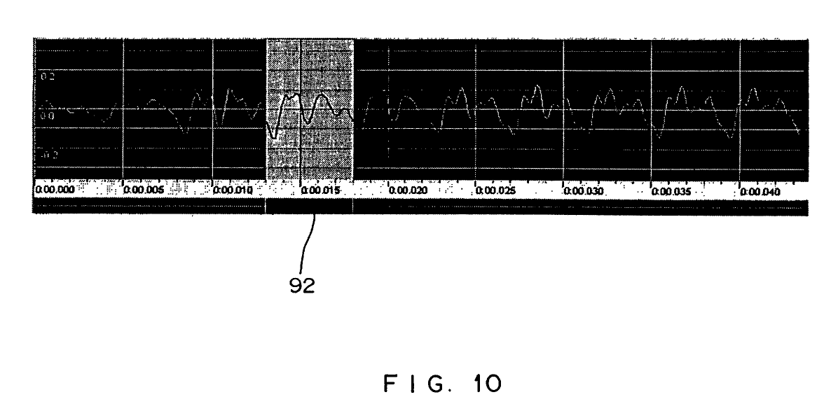

FIG. 10 shows a target frame 92, the correlation with the focused frame 91 of which is calculated. This target frame 92 corresponds to an area obtained by shifting the original frame 91 backward by an arbitrary number of samples (usually smaller than the frame size), and its size is equal to the frame size.

Then, the auto-correlation between the focused frame 91 and the target frame 92 is calculated. An auto-correlation is obtained by multiplying each sample value of the focused frame 91 by each sample value of the target frame 92, summing the products of all samples included in one frame and dividing the sum by the power of the focused frame 91 (obtained by summing the square values of all samples and dividing the sum by time) and the power of the target frame 92. This auto-correlation is expressed as a floating point number within a range of ±1.

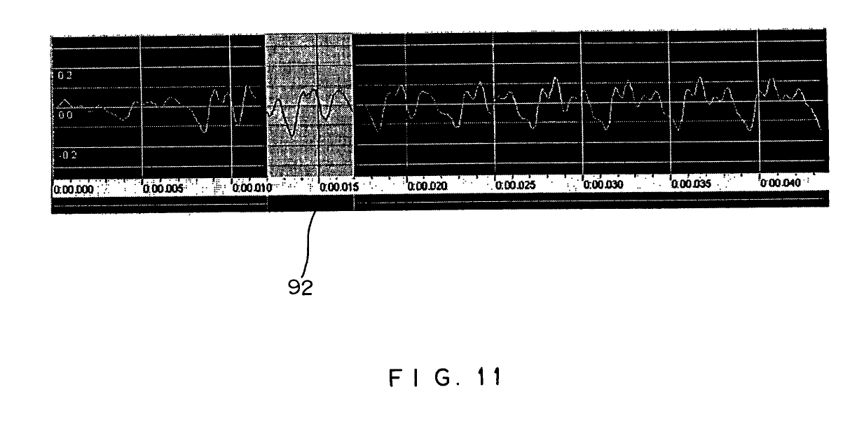

When the correlation calculation finishes, as shown in FIG. 11, the target frame 92 is shifted backward in the direction of the time axis by one sample, and similarly, another auto-correlation is calculated. However, FIG. 11 shows a frame shifted backward by more than one sample, for convenience's sake.

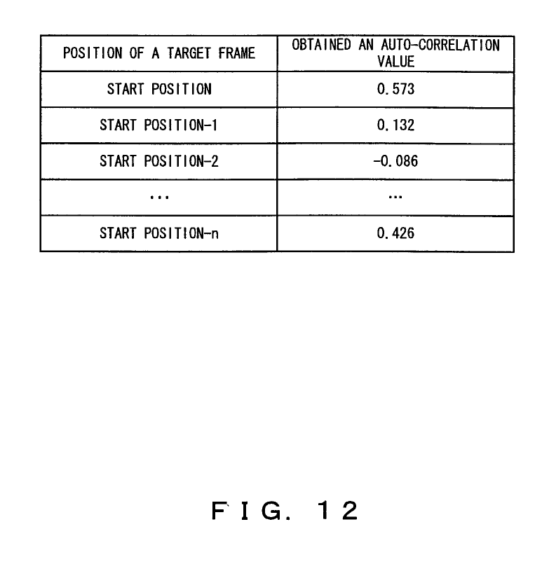

By repeating such a process while shifting the target frame 92 to an arbitrary position n, the auto-correlation array shown in FIG. 12 can be obtained. Then, the position of the target frame 92, in which the auto-correlation value becomes a maximum, is extracted from this auto-correlation array as a pitch position.

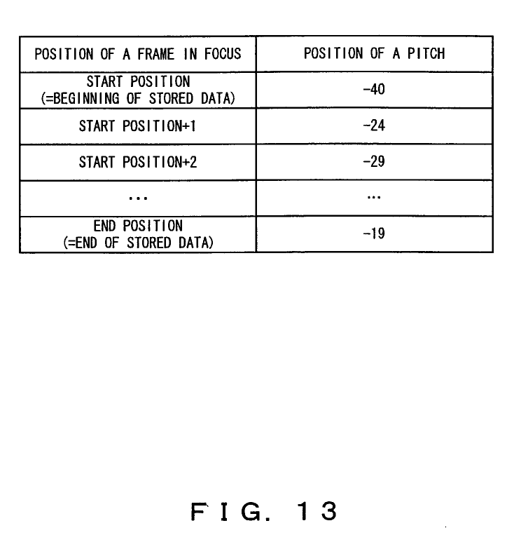

By repeating the same process while shifting the focused frame 91 forward, the pitch position at each position of the focused frame 91 can be calculated, and the pitch distribution shown in FIG. 13 can be obtained.

Then, in order to eliminate data in which a pitch position is not normally extracted from the obtained pitch distribution, data statistically within a +5% range of the minimum value and within a −5% range of the maximum value is discarded. A frequency corresponding to a pitch position located at the center of the remaining data is calculated as a base pitch frequency.

The volume measurement unit 71 calculates the average value of the volumes of stored data. For example, if a value obtained by summing all the square values of the samples of stored data (square sum) and dividing the sum by the time length of the stored data is expressed in logarithm, a volume in units of decibels can be obtained.

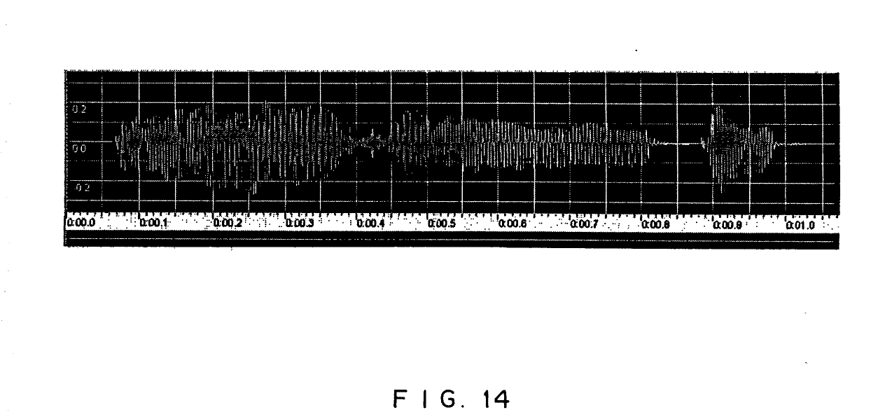

However, as shown in FIG. 14, actual stored data includes many silent parts. In the stored data shown in FIG. 14, the top and end of the data and a part immediately before the last data aggregate correspond to silent parts. If such data is processed without modification, the volume value of stored data including many silent parts and the volume value of stored data hardly including a silent part become low and high, respectively, for the same speech content.

In order to prevent such a phenomenon, the square sum of only the voiced parts of stored data is often calculated instead of calculating the square sum of all the samples of the stored data and the sum is divided by the time length of the voiced parts.

The speed measurement unit 81 calculates the speed of stored data. Speech speed is expressed by the number of morae or syllables per minute. For example, in the case of Japanese and English, the number of morae and the number of syllables, respectively, are used.

In order to calculate the speed, it is passable if the phonetic character string of target stored data is clarified. A phonetic character string can be usually obtained by applying a voice synthesis language process to an input character string.

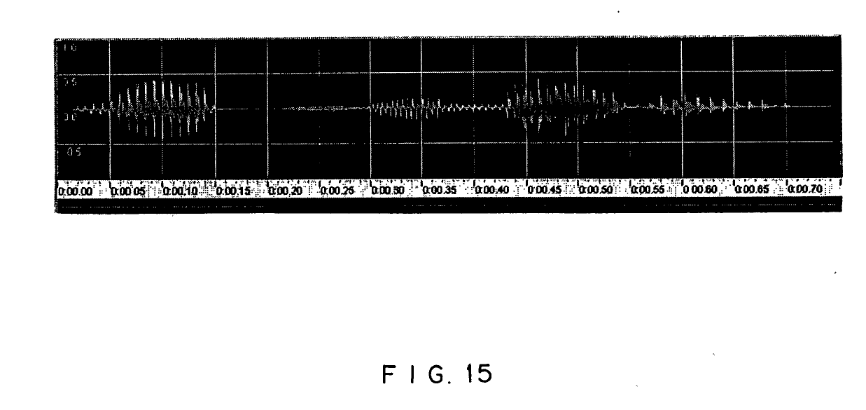

For example, if the speech content of stored data as shown in FIG. 15 is a Japanese word “matsubara”, a phonetic character string “matsubara” can be obtained by a voice synthesis language process. Since “matsubara” comprises four morae, and the data length of the stored data shown in FIG. 15 is approximately 0.75 seconds, the speed becomes approximately 5.3 morae/second.

The synthesized voice data generating unit 56 performs voice synthesis such that the synthesized voice data fit a parameter, such as a base pitch frequency, volume or speed. A voice synthesis process in accordance with a base pitch frequency is described below as an example.

Although there are a variety of voice synthesis methods, a waveform connecting type voice synthesis is briefly described below. According to this method, synthesized voice data can be generated by storing in advance the waveform data of each phoneme in a waveform dictionary and selecting/combining each of the phoneme waveforms with one another.

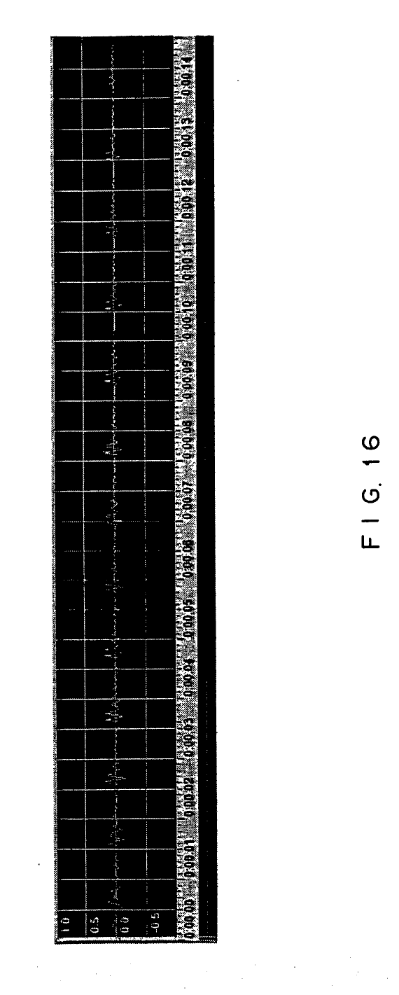

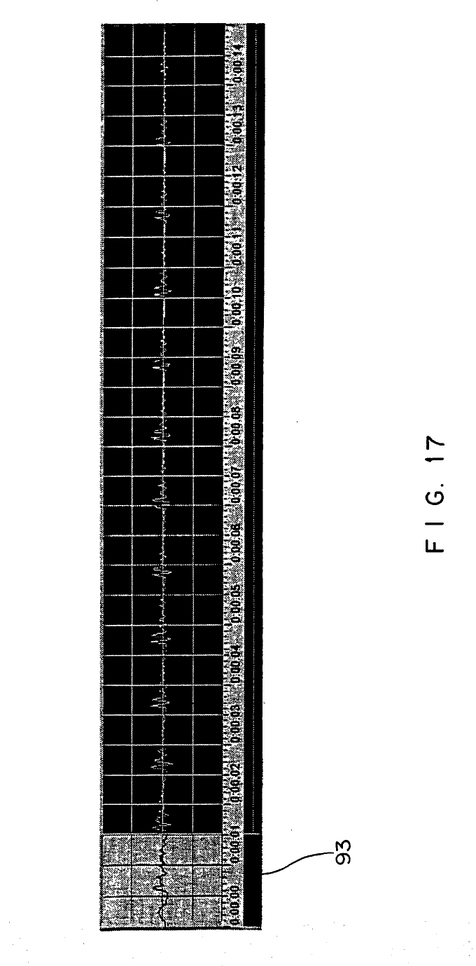

A waveform of a phoneme is a waveform as shown in FIG. 16, for example. FIG. 16 shows a waveform of a phoneme “ma”. FIG. 17 shows the consonant part of “ma”, which is an area 93. The remaining part represent the vowel part “a” of “ma”, and the waveform corresponding to “a” is repeated in the remaining part.

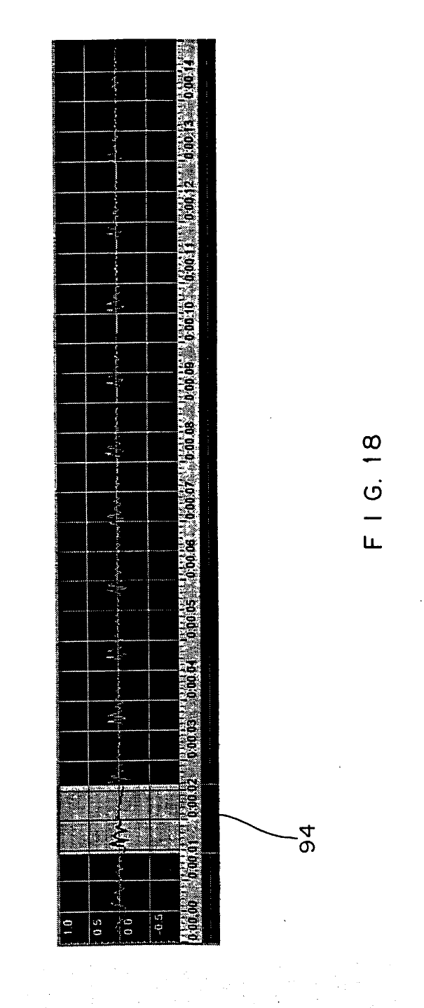

In the waveform connecting type, for example, a waveform corresponding to the area 93 shown in FIG. 17 and a voice waveform corresponding to the area 94 for one cycle of the vowel part of “ma” shown in FIG. 18 are prepared in advance. Then, these waveforms are combined according to voice data to be generated.

In this case, the pitch of voice data varies depending on an interval, at which a plurality of vowel parts are located. The shorter the interval, the higher the pitch, and the longer the interval the lower the pitch. The reciprocal number of this interval is called a “pitch frequency”. A pitch frequency can be obtained by adding a phrase factor determined by the sentence content to be read, an accent factor and a sentence end factor, to a base pitch frequency specific to each individual.

Therefore, if a base pitch frequency is given in advance, synthesized voice data to fit the base pitch frequency can be generated by calculating a pitch frequency using the base pitch frequency and arraying each phoneme waveform according to the pitch frequency.

The measurement method of the pitch measurement unit 54, volume measurement unit 71 or speed measurement unit 81 and the voice synthesis method of the synthesized voice data generating unit 56 are not limited to the methods described above, and an arbitrary algorithm can be adopted.

The voice synthesis process of the present invention can be applied to not only a Japanese character string, but also a character string of any language, including English, German, French, Chinese and Korean.

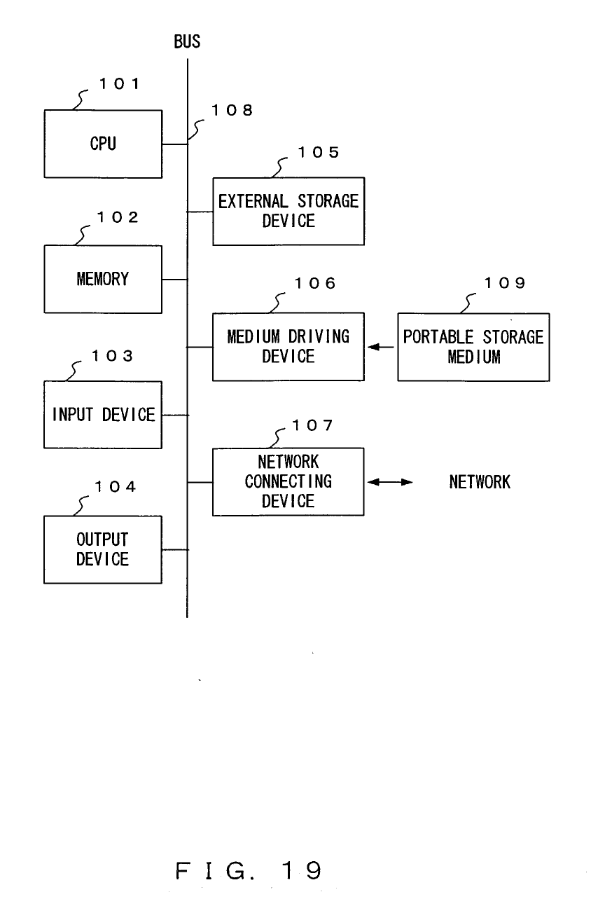

Each of the voice synthesis systems shown in FIGS. 5A, 6A and 7A can be configured using the information processing device (computer) shown in FIG. 19. The information processing device shown in FIG. 19 comprises a CPU (central processing unit) 101, a memory 102, an input device 103, an output device 104, an external storage device 105, a medium driving device 106 and a network connecting device 107, and the devices are connected to one another by a bus 108.

The memory 102 is, for example, a ROM (read-only memory), a RAM (random-access memory) or the like, and stores programs and data to be used for the process. The CPU 101 performs necessary processes by using the memory 102 and executing the programs.

In this case, each of the character string analysis unit 51, stored data extraction unit 52, pitch measurement unit 54, pitch setting unit 55, synthesized voice data generating unit 56 and waveform combining unit 58 that are shown in FIG. 5A, the volume measurement unit 71 and volume setting unit 73 that are shown in FIG. 6A, and the speed measurement unit 81 and speed setting unit 83 that are shown in FIG. 7A, correspond to each program stored in the memory 102.

The input device 103 is, for example, a keyboard, a pointing device, a touch panel or the like, and is used by an operator to input instructions and information. The output device 104 is, for example, a speaker or the like, and is used to output voice data.

The external storage device 105 is, for example, a magnetic disk device, an optical disk device, a magneto-optical disk device, a tape device or the like. The information processing device stores the programs and data described above in this external storage device 105, and uses them by loading them into the memory 57, as requested. The external storage device 105 is also used to store data of the database 53 and waveform dictionary 57 that are shown in FIG. 5A

The medium driving device 106 drives a portable storage medium 109 and accesses its recorded contents. For the portable storage medium, an arbitrary computer-readable storage medium, such as a memory card, a flexible disk, a CD-ROM (compact-disk read-only memory), an optical disk, a magneto-optical disk or the like, is used. The operator stores the programs and data described above in this portable storage medium 109 in advance, and uses them by loading them into the memory 102, as requested.

The network connecting device 107 is connected to an arbitrary communication network, such as a LAN (local area network) or the like, and transmits/receives data accompanying communication. The information processing device receives the programs and data described above from another device through the network connecting device 107, and uses them by loading them into the memory 102, as requested.

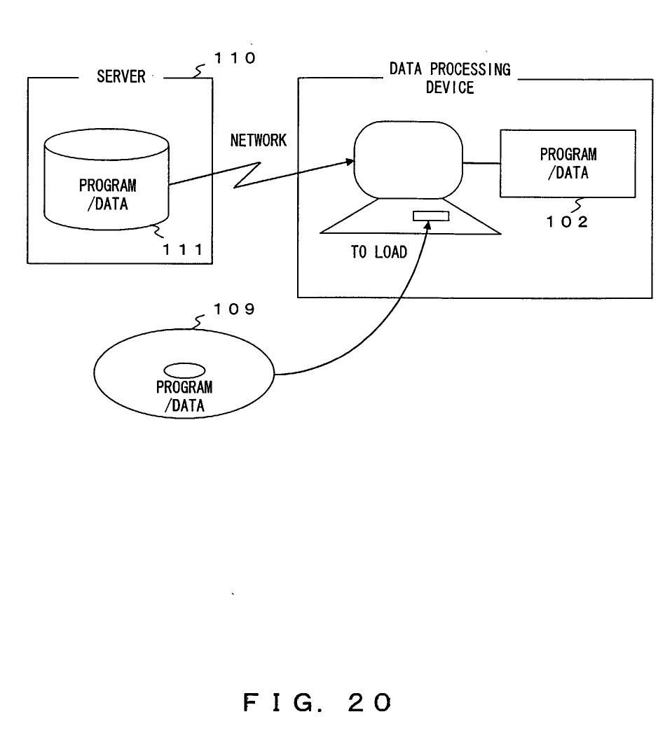

FIG. 20 shows examples of a computer-readable storage medium providing the information processing device shown in FIG. 19 with such programs and data. The programs and data stored in the portable storage medium 109 or the database 111 of a server 110 are loaded into the memory 102. In this case, the server 110 generates propagation signals propagating the programs and data, and transmits them to the information processing device through an arbitrary transmission medium in a network. Then, the CPU 101 executes the programs using the data to perform necessary processes.

According to the present invention, since voice discontinuity between recorded voice data and synthesized voice data decreases, more natural voice data can be generated.

What is claimed is:

1. A voice synthesis system comprising:
a storage device storing recorded voice data in relation to each of a plurality of partial character strings;
an analysis device analyzing an input character string and determining a partial character string for which to use recorded voice and a partial character string for which to use synthesized voice;
an extraction device extracting voice data for the partial character string for which to use recorded voice from the storage device and extracting a feature amount from the extracted voice data;
a synthesis device synthesizing voice data to fit the extracted feature amount for the partial character string for which to use synthesized voice; and
an output device combining and outputting the extracted voice data and the synthesized voice data.

2. A voice synthesis system comprising:
a storage device storing recorded voice data in relation to each of a plurality of partial character strings;
an analysis device analyzing an input character string and determining a partial character string for which to use recorded voice and a partial character strings for which to use synthesized voice;
an extraction device extracting voice data for the partial character string for which to use recorded voice from the storage device and extracting a base pitch from the extracted voice data;
a synthesis device synthesizing voice data to fit the extracted base pitch for the partial character string for which to use synthesized voice; and
an output device combining and outputting the extracted voice data and the synthesized voice data.

3. A voice synthesis system comprising:
a storage device storing recorded voice data in relation to each of a plurality of partial character strings;
an analysis device analyzing an input character string and determining a partial character string for which to use recorded voice and a partial character string for which to use synthesized voice;
an extraction device extracting voice data for the partial character string for which to use recorded voice from the storage device and extracting a volume from the extracted voice data;
a synthesis device synthesizing voice data to fit the extracted volume for the partial character string for which to use synthesized voice; and
an output device combining and outputting the extracted voice data and the synthesized voice data.

4. A voice synthesis system comprising:
a storage device storing recorded voice data in relation to each of a plurality of partial character strings;
an analysis device analyzing an input character string and determining a partial character string for which to use recorded voice and a partial character string for which to use synthesized voice;
an extraction device extracting voice data for the partial character string for which to use recorded voice from the storage device and extracting a speed from the extracted voice data;
a synthesis device synthesizing voice data to fit the extracted speed for the partial character string for which to use synthesized voice; and
an output device combining and outputting the extracted voice data and the synthesized voice data.

5. A voice synthesis system comprising:
a storage device storing recorded voice data in relation to each of a plurality of partial character strings;
an analysis device analyzing an input character string and determining a partial character string for which to use recorded voice and a partial character string for which to use synthesized voice;
an extraction device extracting voice data for the partial character string for which to use recorded voice from the storage device and extracting a base pitch, a volume and a speed from the extracted voice data;
a synthesis device synthesizing voice data to fit the extracted base pitch, volume and speed for the partial character string for which to use synthesized voice; and
an output device combining and outputting the extracted voice data and the synthesized voice data.

6. A computer-readable storage medium on which is recorded a program enabling a computer to execute a process, said process comprising:
analyzing an input character string and determining a partial character string for which to use recorded voice and a partial character string for which to use synthesized voice;
extracting voice data for the partial character string for which to use recorded voice from voice data recorded in relation to each of a plurality of partial character strings;
extracting a feature amount from the extracted voice data;
synthesizing voice data to fit the extracted feature amount for the partial character string for which to use synthesized voice; and
combining and outputting the extracted voice data and the synthesized voice data.

7. A propagation signal propagating to a computer a program enabling the computer to execute a process, said process comprising:
analyzing an input character string and determining a partial character string for which to use recorded voice and a partial character string for which to use synthesized voice;
extracting voice data for the partial character string for which to use recorded voice from voice data recorded in relation to each of a plurality of partial character strings;
extracting a feature amount from the extracted voice data;
synthesizing voice data to fit the extracted feature amount for the partial character string for which to use synthesized voice; and
combining and outputting the extracted voice data and the synthesized voice data.

8. A voice synthesis method comprising:
analyzing an input character string and determining a partial character string for which to use recorded voice and a partial character string for which to use synthesized voice;
extracting voice data for the partial character string for which to use recorded voice from voice data recorded in relation to each of a plurality of partial character strings;
extracting a feature amount from the extracted voice data;
synthesizing voice data to fit the extracted feature amount for the partial character string for which to use synthesized voice; and
combining and outputting the extracted voice data and the synthesized voice data.

9. A voice synthesis system comprising:
storage means for storing recorded voice data in relation to each of a plurality of partial character strings;
analysis means for analyzing an input character string and determining a partial character string for which to use recorded voice and a partial character string for which to use synthesized voice;
extraction means for extracting voice data for the partial character string for which to use recorded voice from the storage device and extracting a feature amount of the extracted voice data;
synthesis means for synthesizing voice data to fit the extracted feature amount for the partial character string for which to use synthesized voice; and
output means for combining and outputting the extracted voice data and the synthesized voice data.
